(19) United States
(12) Patent Application Publication
(10) Pub. No.: US 2025/0282148 A1
(43) Pub. Date: Sep. 11, 2025

(54) INKJET PRINTING APPARATUS

(71) Applicant: SCREEN Holdings Co., Ltd., Kyoto (JP)

(72) Inventors: Hideaki ONISHI, Kyoto-shi (JP); Takanori TSUJI, Kyoto-shi (JP)

(21) Appl. No.: 19/023,812

(22) Filed: Jan. 16, 2025

(30) Foreign Application Priority Data
Mar. 8, 2024 (JP) 2024-035467

(51) Int. Cl. B41J 2/18; B41J 2/17; B41J 2/175; B41J 2/195

(52) U.S. Cl. CPC B41J 2/18; B41J 2/1728; B41J 2/17596; B41J 2/195

(57) ABSTRACT

In this inkjet printing apparatus, an ink separation region is set in a partial region including a heater in a feedback pipe that connects an internal collecting tank and a supply tank on an ink circulation path. The ink separation region is a region in which ink in the circulation path is separated from ink in the other regions in the feedback pipe when ink circulation stops. A control unit selectively performs a normal resumption mode and a post-drainage resumption mode in accordance with a temperature of ink in the ink separation region before resuming ink circulation in the circulation path. In the post-drainage resumption mode, after at least a part of ink in the ink separation region is drained to an external collecting tank, the ink separation region and the other regions in the feedback pipe are caused to communicate with each other.

### RELATED APPLICATIONS

This application claims the benefit of Japanese application No. 2024-035467, filed on 8 Mar. 2024, the disclosure of which is incorporated by reference herein.

### BACKGROUND OF THE INVENTION

### Field of the Invention

The present invention relates to an inkjet printing apparatus that discharges ink onto a printing medium such as paper to perform printing.

### Description of the Background Art

Conventionally, an inkjet printing apparatus includes an ink circulation path through which ink is supplied to a discharge head configured to discharge ink onto a printing medium, and ink being left undischarged in the discharge head is collected and again supplied to the discharge head, in some cases. An inkjet printing apparatus including such an ink circulation path as mentioned above is described in, for example, Japanese Patent Application Laid-Open No. 2012-006261.

An image recorder (1) in Japanese Patent Application Laid-Open No. 2012-006261 includes an ink circulation unit (3a). The ink circulation unit (3a) includes a first ink circulation path (14) and a second ink circulation path (15), and thus, two kinds of ink are circulated. Further, the first ink circulation path (14) and the second ink circulation path (15) are connected to an image recording unit (4). Ink is circulated through each of the first ink circulation path (14) and the second ink circulation path (15), and thus ink is supplied to each nozzle row (11) of the image recording unit (4) (paragraph [0027]). Meanwhile, a heat exchanger (23a) is provided across the first ink circulation path (14) and the second ink circulation path (15) (paragraph [0028] and FIG. 2).

Here, for example, consider a case in which an image is recorded while ink is circulated through only the first circulation path (14) to which ink of K color is charged. In this case, when ink is discharged from the nozzle row (11), driving heat is generated in the image recording unit (4), and a temperature of ink being delivered through the first ink circulation path (14) is gradually increased. At that time, in the heat exchanger (23), whereas ink therein is cooled by heat dissipation using a heat-dissipating fin (65), the cooling performance is gradually degraded (paragraphs [0041] and [0042]). Then, a control unit (2) starts circulating ink through the second ink circulation path (15) that is not used in image recording (paragraph [0043]). In this regard, a temperature of ink in the second circulation path (15) is low because the second circulation path (15) has not been used in image recording. The ink at a low temperature is delivered to the heat exchanger (23), and thus, heat can be absorbed and the temperature can be lowered (paragraph [0044]).

However, if the image recording apparatus (1) and the ink circulation unit (3a) stop due to a reason such as a power failure, delivery of ink through the second ink circulation path (15) to the heat exchanger (23) for ink also stops. In such a case, the temperature of ink in the first circulation path (14) is kept high and is likely to be changed in quality or deteriorated. To directly use ink having been changed in quality or deteriorated for image recording would cause a fear that ink might not be satisfactorily discharged from the nozzle row (11) or a desired color gamut might not be obtained. For this reason, in recovering after a stop of the image recording apparatus (1) and the ink circulation unit (3a), it is required to perform waste liquid treatment on ink having been changed in quality or deteriorated. However, to perform waste liquid treatment on all of ink in the first ink circulation path (14) would incur much loss, probably reducing workability.

### SUMMARY OF THE INVENTION

It is an object of the present invention to provide a technology that enables drainage of ink that is likely to have been changed in quality or deteriorated due to overheating during a stop of ink circulation, to the outside, in recovery afterward, and further, enables reduction of an amount of ink to be drained at that time.

To solve the above-described problem, the first invention of the present application is directed to an inkjet printing apparatus that discharges ink onto a printing medium to perform printing, and includes an ink circulation path, an external collecting tank, a circulation pump, a heater, a control unit, and an ink separation region. The circulation path includes a discharge head configured to discharge ink, a supply tank in which ink supplied to the discharge head is stored, an internal collecting tank in which ink collected from the discharge head is stored, and a feedback pipe connecting the internal collecting tank and the supply tank. In the external collecting tank, ink drained to outside of the circulation path is collected. The circulation pump is interposed in the feedback pipe and is configured to deliver ink from the internal collecting tank to the supply tank via the feedback pipe. The heater is interposed between the circulation pump and the supply tank in the feedback pipe and is configured to heat ink flowing from the internal collecting tank to the supply tank. The control unit is configured to control the discharge head, the circulation pump, and the heater, and detect presence or absence of ink circulation in the circulation path. The ink separation region is set in a partial region including the heater in the feedback pipe. In the ink separation region, ink in the circulation path is separated from ink in the other regions in the feedback pipe when the ink circulation in the circulation path stops. The control unit selectively performs a normal resumption mode and a post-drainage resumption mode before resuming the ink circulation in the circulation path in accordance with a temperature of the ink in the ink separation region. In the normal resumption mode, the ink separation region and the other regions in the feedback pipe are caused to communicate with each other immediately. In the post-drainage resumption mode, the ink separation region and the other regions in the feedback pipe are caused to communicate with each other after at least a part of ink in the ink separation region is drained to the external collecting tank.

The second invention of the present application is directed to the inkjet printing apparatus according to the first invention, further including an on-off valve and a switch valve in the ink separation region. The on-off valve is interposed between the circulation pump and the heater in the feedback pipe and is configured to allow or interrupt ink flow from the internal collecting tank to the supply tank. The switch valve is interposed between the heater and the supply tank in the feedback pipe and is configured to perform switching between a state in which the heater and the supply tank communicate with each other and a state in which the heater and the supply tank are blocked from communicating with each other, and in the latter state, an inner space of the circulation path and the external collecting tank communicate with each other. The control unit is configured to further control the on-off valve and the switch valve. Under the control of the control unit, the on-off valve is closed, and the ink separation region and the external collecting tank are caused to communicate with each other at the switch valve, so that the ink in the ink separation region is separated from the ink in the other regions in the feedback pipe.

The third invention of the present application is directed to the inkjet printing apparatus according to the second invention, wherein, in the post-drainage resumption mode, under the control of the control unit, the on-off valve is opened, and the circulation pump is driven while the ink separation region and the external collecting tank communicate with each other at the switch valve, so that at least the part of the ink in the ink separation region is drained to the external collecting tank.

The fourth invention of the present application is directed to the inkjet printing apparatus according to any of the first to third inventions, wherein the control unit determines whether the temperature of the ink in the ink separation region is lower than a predetermined threshold value, or is equal to or higher than the predetermined threshold value, performs the normal resumption mode when it is determined that the temperature of the ink in the ink separation region is lower than the predetermined threshold value, and performs the post-drainage resumption mode when it is determined that the temperature of the ink in the ink separation region is equal to or higher than the predetermined threshold value.

The fifth invention of the present application is directed to the inkjet printing apparatus according to the fourth invention, wherein the control unit determines whether the temperature of the ink in the ink separation region is lower than, or equal to or higher than, the predetermined threshold value on the basis of a duty value of the heater for a first predetermined time period before it is detected that the ink circulation in the circulation path has stopped.

The sixth invention of the present application is directed to the inject printing apparatus according to the fourth invention, further including a temperature sensor that is interposed between the heater and the switch valve in the feedback pipe and is configured to detect a temperature of ink in the feedback pipe. The control unit determines whether the temperature of the ink in the ink separation region is lower than, or equal to or higher than, the predetermined threshold value on the basis of a result of detection provided from the temperature sensor.

The seventh invention of the present application is directed to the inkjet printing apparatus according to any of the first to sixth inventions, wherein, in performing the post-drainage resumption mode, the control unit stops driving the heater at least until the ink separation region and the other regions in the feedback pipe communicate with each other.

The eighth invention of the present application is directed to the inkjet printing apparatus according to the second invention, further including a first heater and a second heater that are interposed in the feedback pipe while being arranged adjacently to each other along the circulation path, as the heater. The second heater is positioned on a downstream side of the first heater in the circulation path and has a duty value greater than a duty value of the first heater. Before resuming the ink circulation in the circulation path, the control unit determines whether a temperature of ink in the first heater is lower than, or equal to or higher than, a first predetermined threshold value, and whether a temperature of ink in the second heater is lower than, or equal to or higher than, a second predetermined threshold value. When it is determined that the temperature of the ink in the first heater is lower than the first predetermined threshold value and the temperature of the ink in the second heater is equal to or higher than the second predetermined threshold value, the control unit performs the post-drainage resumption mode in which the inner space of the circulation path and the external collecting tank are caused to communicate with each other at the switch vale, the circulation pump is driven for a specific time period, the ink in the ink separation region is drained to the external collecting tank, and then, the ink separation region and the other regions in the feedback pipe are caused to communicate with each other at the switch valve. The specific time period is obtained by division of a specific capacity calculated from an ink-passable capacity of the second heater, by a pumping amount of the circulation pump per unit time period.

According to the first to eighth inventions of the present application, ink that is likely to have been changed in quality or deteriorated due to overheating during a stop of ink circulation can be drained to the outside in accordance with a temperature of ink, in recovery afterward. Further, a smaller amount of ink than all ink in the circulation path can be drained, and hence, an amount of ink to be drained can be reduced.

Especially, according to the second invention of the present application, ink in the ink separation region is separated from ink in the other regions in the feedback pipe using the on-off valve and the switch valve, which ensures separation of ink.

Especially, according to the third invention of the present application, in the post-drainage resumption mode, ink is drained to the external collecting tank by driving of the circulation pump, which ensures drainage of ink.

Especially, according to the fifth invention of the present application, ink can be drained in accordance with a result of determination as to whether the ink temperature is lower than, or equal to or higher than, the threshold value, with consideration of a heating value of the heater.

Especially, according to the sixth invention of the present application, the temperature of the ink in the ink separation region is detected using the temperature sensor, which enables more accurate detection of the ink temperature.

Especially, according to the seventh invention of the present application, overheating of ink can be further suppressed.

Especially, according to the eighth invention of the present application, ink that is likely to have been changed in quality or deteriorated due to overheating by the second heater can be drained to the outside in accordance with the temperature of the ink. Further, it is possible to narrow ink to be drained at that time, down to ink that is likely to have been changed in quality or deteriorated due to overheating by the second heater.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view conceptually showing a configuration of an inkjet printing apparatus;

FIG. 2 is a view conceptually showing configurations of an ink supply unit and a discharge head;

FIG. 3 is a block diagram showing connection between a control unit and each component of the inkjet printing apparatus;

FIG. 4 is a flowchart showing a flow including conveyance of a continuous paper, printing on the continuous paper, ink circulation, and ink drainage to the outside;

FIG. 5 is a view showing a relationship between a temperature of ink passing through a heater and a duty value of the heater, plotted against the temperature; and

FIG. 6 is a flowchart showing a procedure for performing a post-recovery process.

### DESCRIPTION OF THE PREFERRED EMBODIMENTS

Hereinafter, a preferred embodiment of the present invention will be described with reference to the drawings. Note that components described in the preferred embodiment are mere examples and are not intended to limit the scope of the present invention to those only. In the drawings, for the purpose of easier understanding, the dimensions or the number of respective components are overstated or understated in some portions of illustration, as necessary.

### <1. Configuration of Inkjet Printing Apparatus>

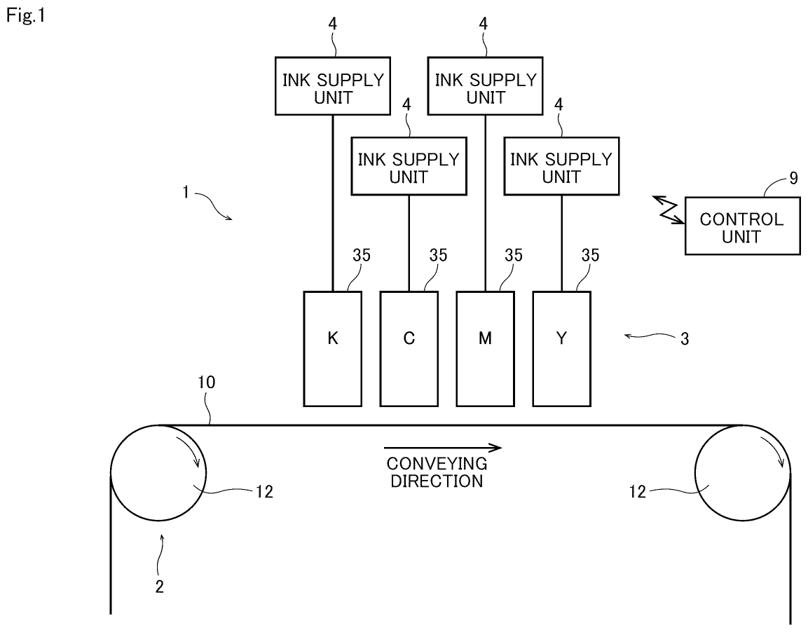

FIG. 1 is a view conceptually showing a configuration of an inkjet printing apparatus 1 according to one preferred embodiment of the present invention. The inkjet printing apparatus 1 is an inkjet printing machine that discharges droplets of water-based ink, from a plurality of discharge heads 35, onto continuous paper 10 being in a shape of a long strip, while conveying the continuous paper 10, to record characters or images on a surface of the continuous paper 10. Note that the continuous paper 10 in a shape of a long strip is just one example of a printing medium. The printing medium may be a cut sheet, a plastic film, a cardboard, metal foil, a glass material, or the like. In other words, the inkjet printing apparatus 1 may be any apparatus that can discharge ink onto a printing medium to perform printing. As shown in FIG. 1, the inkjet printing apparatus 1 includes a conveyor unit 2, a printing unit 3, and a control unit 9.

The conveyor unit 2 is a mechanism configured to convey the continuous paper 10 along a predetermined conveying path in a conveying direction extending along a length direction of the continuous paper 10. The continuous paper 10 is stretched over a plurality of conveyor rollers 12. The continuous paper 10 is conveyed along a conveying path formed by the plurality of conveyor rollers 12. Each of the conveyor rollers 12 rotates about an axis extending in a direction perpendicular to the conveying direction, to thereby guide the continuous paper 10 to the downstream side in the conveying path. Further, the continuous paper 10 is under tension in the conveying direction. This reduces slack or wrinkles in the continuous paper 10 during conveying.

The printing unit 3 includes a plurality of discharge heads 35 and a plurality of ink supply units 4. In the present preferred embodiment, the printing unit 3 includes four discharge heads 35 and four ink supply units 4. The four discharge heads 35 have substantially the same configuration with each other. Further, the four ink supply units 4 have substantially the same configuration with each other.

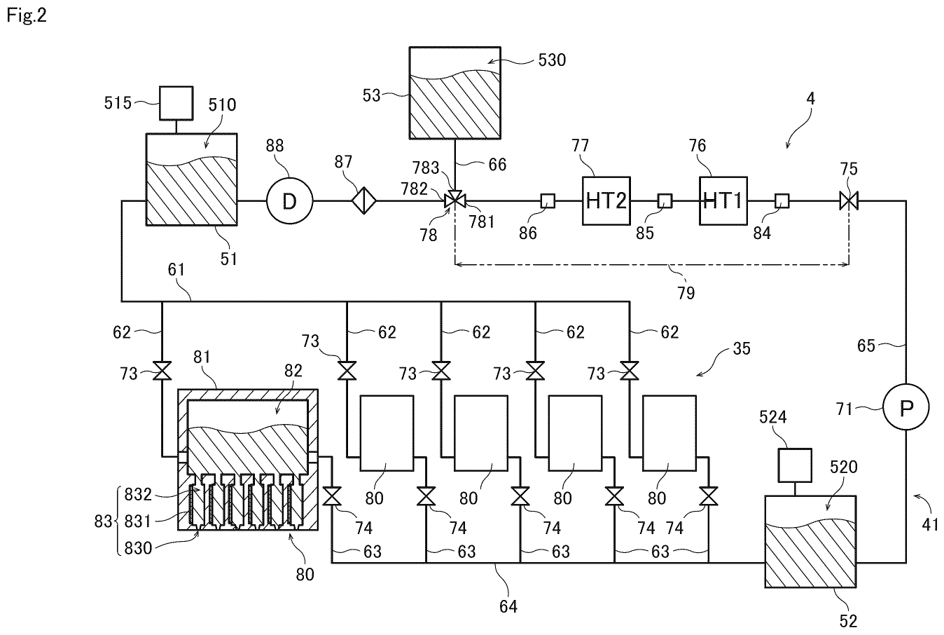

The four discharge heads 35 are arranged while being spaced from each other along the conveying direction. Each of the four discharge heads 35 discharges ink droplets onto a surface (upper surface) of the continuous paper 10 from nozzles 83 (refer to FIG. 2 described later). In the present preferred embodiment, the four discharge heads 35 discharge ink of different colors, respectively, to thereby each record a monochromatic image on the surface (upper surface) of the continuous paper 10. For example, the four discharge heads 35 discharge cyan ink, magenta ink, yellow ink, and black ink, respectively. Then, the four monochromatic images are superimposed, so that a multicolor image is formed on the upper surface of the continuous paper 10.

FIG. 2 is a view conceptually showing a configuration of one ink supply unit 4 and a configuration of one discharge head 35. In the present preferred embodiment, each of the discharge heads 35 includes a plurality of heads 80. In the present preferred embodiment, each of the discharge heads 35 includes five heads 80. The five heads 80 have substantially the same configuration with each other. Hence, in FIG. 2, only one of the five heads 80 is shown in detail, and the other four heads 80 are shown in a simplified manner. As shown in FIG. 2, each of the five heads 80 includes a casing 81, an internal tank 82, and a plurality of nozzles 83.

The casing 81 forms an outer frame of the head 80. The internal tank 82 is provided in the casing 81, and ink can be temporarily stored therein. The plurality of nozzles 83 are arranged while being equally spaced from each other along the conveying direction and a width direction of the continuous paper 10 in a lower portion of the casing 81. Each of the plurality of nozzles 83 communicates with the internal tank 82. Further, each of the plurality of nozzles 83 includes a plurality of piezoelectric elements 831 serving as pressure generation elements, an ink chamber 832, and a discharge port 830. The ink chamber 832 communicates with the internal tank 82.

During discharge of ink, ink flows down from the internal tank 82 to the ink chamber 832. Then, under the control of the piezoelectric elements 831, ink in the ink chamber 832 is pressurized, and thus is discharged in the form of liquid droplets from the discharge port 830. Alternatively, the nozzle 83 may be a thermal nozzle in which ink in the ink chamber 832 is heated to generate bubbles and thus is pressurized.

Next, the ink supply unit 4 is described. The ink supply unit 4 is a device configured to supply ink to the discharge heads 35 while circulating a part of ink. As described above, the inkjet printing apparatus 1 of the present preferred embodiment includes four ink supply units 4. The four ink supply units 4 have substantially the same configuration with each other, and hence only a configuration of one ink supply unit 4 is described below.

As shown in FIG. 2, each of the ink supply units 4 includes a supply tank 51, an internal collecting tank 52, an external collecting tank 53, a supply-side manifold 61, a plurality of supply-side narrow pipes 62, a plurality of collecting-side narrow pipes 63, a collecting-side manifold 64, a feedback pipe 65, a drainage pipe 66, a circulation pump 71, a plurality of supply-side on-off valves 73, a plurality of head outlet-side on-off valves 74, a feedback-side on-off valve 75, a first heater 76, a second heater 77, a switch valve 78, a first temperature sensor 84, a second temperature sensor 85, a third temperature sensor 86, a filter 87, and a deaeration unit 88. In the present preferred embodiment, each of the ink supply units 4 includes five supply-side narrow pipes 62, five collecting-side narrow pipes 63, five supply-side on-off valves 73, and five head outlet-side on-off valves 74.

The supply tank 51 is a container for temporally storing ink to be supplied to the discharge heads 35. In the supply tank 51, an internal chamber 510 in which ink can be temporally stored is provided. Meanwhile, in the supply tank 51, a liquid-level sensor for detecting a liquid level of ink stored in the internal chamber 510 of the supply tank 51 may be provided.

The supply-side manifold 61 and the five supply-side narrow pipes 62 are pipes connecting the supply tank 51 and the five heads 80 included in one discharge head 35. The supply-side manifold 61 is a wide pipe having an upstream end that is connected so as to communicate with the internal chamber 510 of the supply tank 51. Each of the five supply-side narrow pipes 62 is a narrow pipe branching from the supply-side manifold 61. Each of the five supply-side narrow pipes 62 has an upstream end communicating with an internal passage of the supply-side manifold 61, and has a downstream end that is connected so as to communicate with the internal tank 82 of one head 80.

Further, in the present preferred embodiment, the supply-side on-off valve 73 is interposed in each of the supply-side narrow pipes 62. For the supply-side on-off valve 73, for example, a solenoid valve that is opened and closed under the control of the control unit 9 is used. Alternatively, for the supply-side on-off valve 73, an on-off valve that is manually opened and closed may be used. While the supply-side on-off valve 73 is closed, an internal passage of the supply-side narrow pipe 62 is blocked from communicating. That is, while the supply-side on-off valve 73 is closed, ink flow from the supply tank 51 to the head 80 is interrupted. Meanwhile, while the supply-side on-off valve 73 is opened, the internal passage of the supply-side narrow pipe 62 is allowed to communicate. Note that the supply-side on-off valve 73 is not necessarily required to be provided. Further, a filter or the like may be further interposed in the supply-side manifold 61 or each of the five supply-side narrow pipes 62.

The five collecting-side narrow pipes 63 and the collecting-side manifold 64 are pipes connecting the five heads 80 included in one discharge head 35 and the internal collecting tank 52. Each of the five collecting-side narrow pipes 63 is a narrow pipe branching from the collecting-side manifold 64. Each of the five collecting-side narrow pipes 63 has an upstream end that is connected so as to communicate with the internal tank 82 of one head 80, and has a downstream end that is connected so as to communicate with an internal passage of the collecting-side manifold 64. The collecting-side manifold 64 is a wide pipe having a downstream end that is connected so as to communicate with the internal chamber 520 of the internal collecting tank 52 described later.

Further, in the present preferred embodiment, the head outlet-side on-off valve 74 is interposed in each of the collecting-side narrow pipes 63. For the head outlet-side on-off valve 74, for example, a solenoid valve that is opened and closed under the control of the control unit 9 is used. Alternatively, for the head outlet-side on-off valve 74, an on-off valve that is manually opened and closed may be used. While the head outlet-side on-off valve 74 is closed, an internal passage of the collecting-side narrow pipe 63 is blocked from communicating. That is, while the head outlet-side on-off valve 74 is closed, ink flow from the head 80 to the internal collecting tank 52 is interrupted. Meanwhile, while the head outlet-side on-off valve 74 is opened, the internal passage of the collecting-side narrow pipe 63 is allowed to communicate. Note that the head outlet-side on-off valve 74 is not necessarily required to be provided. Further, a filter or the like may be further interposed in each of the five collecting-side narrow pipes 63 or the collecting-side manifold 64.

The internal collecting tank 52 is a container for temporally storing ink collected from the discharge heads 35. In the internal collecting tank 52, the internal chamber 520 in which ink can be temporally stored is provided. Meanwhile, in the internal collecting tank 52, a liquid-level sensor for detecting a liquid level of ink stored in the internal chamber 520 of the internal collecting tank 52 may be provided.

Further, as shown in FIG. 2, the supply tank 51 is connected to a pressurization mechanism 515. The pressurization mechanism 515 pressurizes the inside of the supply tank 51, to regulate a pressure of the internal chamber 510 of the supply tank 51 to a positive pressure. That is, the pressurization mechanism 515 pressurizes the inside of the supply tank 51, to regulate a pressure of the internal chamber 510 of the supply tank 51 to a pressure higher than the atmospheric pressure. The pressurization mechanism 515 includes, for example, a compressor, a pressurization buffer tank, a pressure regulation mechanism (regulator), and the like. Meanwhile, the internal collecting tank 52 is connected to a decompression mechanism 524. The decompression mechanism 524 decompresses the inside of the internal collecting tank 52, to regulate a pressure of the internal chamber 520 of the internal collecting tank 52 to a negative pressure. That is, the decompression mechanism 524 decompresses the inside of the internal collecting tank 52, to regulate a pressure of the internal chamber 520 of the internal collecting tank 52 to a pressure lower than the atmospheric pressure. The decompression mechanism 524 includes, for example, a vacuum pump, a decompression buffer tank, a pressure regulation mechanism (regulator), and the like.

The pressurization mechanism 515 and the decompression mechanism 524 are configured such that the operations thereof can be controlled by the control unit 9. When the pressurization mechanism 515 and the decompression mechanism 524 are driven, there is generated a pressure difference between the internal chamber 510 of the supply tank 51 and the internal chamber 520 of the internal collecting tank 52. This allows ink stored in the supply tank 51 to be supplied to the discharge heads 35, and further allows ink remaining in the discharge heads 35 to be collected into the internal collecting tank 52. Note that the ink remaining in the discharge heads 35 is ink being undischarged from the discharge heads 35 and left in the discharge heads 35.

The feedback pipe 65 is a pipe connecting the internal chamber 520 of the internal collecting tank 52 and the internal chamber 510 of the supply tank 51 such that the internal chambers can communicate with each other. In other words, the feedback pipe 65 connects the internal collecting tank 52 and the supply tank 51. As shown in FIG. 2, an internal passage of the feedback pipe 65 has an upstream end that is connected so as to communicate with the internal chamber 520 of the internal collecting tank 52. Further, the internal passage of the feedback pipe 65 has a downstream end that is connected so as to communicate with the internal chamber 510 of the supply tank 51.

With the above-described configuration, there is formed an ink circulation path 41 that extends from the supply tank 51, extends through the supply-side manifold 61, the supply-side narrow pipes 62, the internal tanks 82 of the discharge heads 35, the collecting-side narrow pipes 63, the collecting-side manifold 64, the internal collecting tank 52, and the feedback pipe 65, and returns back to the supply tank 51. In other words, the ink circulation path 41 includes the supply tank 51, the discharge heads 35, the internal collecting tank 52, and the feedback pipe 65.

Further, in the feedback pipe 65, the circulation pump 71, the feedback-side on-off valve 75, the first heater 76, the second heater 77, the switch valve 78, the first temperature sensor 84, the second temperature sensor 85, the third temperature sensor 86, the filter 87, and the deaeration unit 88 are interposed. The switch valve 78 provided in the ink circulation path 41 is further connected to the drainage pipe 66 as later described in detail.

The circulation pump 71 is a device configured to perform a pumping operation of delivering ink from the internal collecting tank 52 to the supply tank 51 via the feedback pipe 65. The circulation pump 71 generates ink flow from the internal collecting tank 52 to the supply tank 51 in the internal passage of the feedback pipe 65 in response to an operation signal from the control unit 9. For the circulation pump 71 of the present preferred embodiment, for example, a pump in which foreign matters such as dust are unlikely to be generated during driving, such as a diaphragm pump, is used. Further, the circulation pump 71 applies a pressure to ink in the circulation pump 71 by reciprocation of a piston therein. Then, the circulation pump 71 discharges ink through an outlet communicating with the internal passage of the feedback pipe 65. Moreover, the circulation pump 71 is electrically connected to the control unit 9. The circulation pump 71 outputs data regarding a driving condition to the control unit 9.

The feedback-side on-off valve 75 is interposed on the downstream side of the circulation pump 71 and on the upstream side of the first heater 76, the second heater 77, and the switch valve 78, in the feedback pipe 65. In other words, the feedback-side on-off valve 75 is interposed between the circulation pump 71 and the first and second heaters 76 and 77 in the feedback pipe 65. The feedback-side on-off valve 75 corresponds to an “on-off valve” of the present invention. For the feedback-side on-off valve 75, for example, a solenoid valve that is opened and closed under the control of the control unit 9 is used. Further, for the feedback-side on-off valve 75 of the present preferred embodiment, a solenoid valve of a normally closed type is used. Thus, with no power supplied, the feedback-side on-off valve 75 is closed. Alternatively, for the feedback-side on-off valve 75, an on-off valve that is manually opened and closed may be used.

While the feedback-side on-off valve 75 is closed, the internal passage of the feedback pipe 65 is blocked from communicating. That is, while the feedback-side on-off valve 75 is closed, ink flow from the internal collecting tank 52 to the supply tank 51 and backflow of ink from the switch valve 78 to the circulation pump 71 are prevented. Meanwhile, while the feedback-side on-off valve 75 is opened, the internal passage of the feedback pipe 65 is allowed to communicate. That is, the feedback-side on-off valve 75 allows or interrupts flow of ink from the internal collecting tank 52 to the supply tank 51.

The first heater 76 is a device configured to heat ink delivered through the internal passage of the feedback pipe 65. The first heater 76 is positioned between the internal collecting tank 52 and the switch valve 78 in the feedback pipe 65. The first heater 76 includes a heating element formed of a carbon heater or the like and is connected to a power supply via an ON/OFF circuit not shown. Then, the first heater 76 can heat ink by generating heat in an ON state in which power is turned on. Further, as later described in detail, the first heater 76 is controlled such that, for example, a temperature of ink passing through the first heater 76 becomes equal to a first target temperature T1° C. higher than a room temperature by switching between an ON state and an OFF state.

The second heater 77 is a device configured to heat ink delivered through the internal passage of the feedback pipe 65. The second heater 77 is positioned between the first heater 76 and the switch valve 78 in the feedback pipe 65. That is, the second heater 77 is positioned on the downstream side of the first heater 76 in the circulation path 41. In other words, in the present preferred embodiment, the first heater 76 and the second heater 77 that are interposed in the feedback pipe 65 while being arranged adjacently to each other along the circulation path 41, are provided. The second heater 77 includes a heating element formed of a carbon heater or the like and is connected to the power supply via the ON/OFF circuit not shown. Then, the second heater 77 can heat ink by generating heat in an ON state in which power is turned on. Further, as later described in detail, the second heater 77 is controlled such that, for example, a temperature of ink passing through the second heater 77 becomes equal to a second target temperature T2° C. higher than the first target temperature T1° C. by switching between an ON state and an OFF state. Note that the second target temperature T2° C. is, for example, approximately 5° C. higher than the first target temperature T1° C. Hereinafter, a ratio of a time period for which each of the first and second heaters 76 and 77 is in an ON state, to a unit time period, is referred to as a “duty value”. The unit time period is, for example, one second. A duty value of the second heater 77 is greater than a duty value of the first heater 76.

However, in the present invention, the number of heaters interposed between the internal collecting tank 52 and the switch valve 78 in the feedback pipe 65 may be one or three or larger. That is, any heater that is interposed between the circulation pump 71 and the supply tank 51 in the feedback pipe 65 and heats ink flowing from the internal collecting tank 52 to the supply tank 51 can be used.

The first temperature sensor 84 is interposed on the downstream side of the feedback-side on-off valve 75 with respect to an ink delivery direction and on the upstream side of the first heater 76 with respect to the ink delivery direction in the feedback pipe 65. The first temperature sensor 84 detects a temperature of ink flowing into the first heater 76. Further, the first temperature sensor 84 is electrically connected to the control unit 9. The first temperature sensor 84 outputs data regarding a result of detection of an ink temperature, to the control unit 9.

The second temperature sensor 85 is interposed on the downstream side of the first heater 76 with respect to the ink delivery direction and on the upstream side of the second heater 77 with respect to the ink delivery direction in the feedback pipe 65. The second temperature sensor 85 detects a temperature of ink flowing out of the first heater 76. Further, the second temperature sensor 85 is electrically connected to the control unit 9. The second temperature sensor 85 outputs data regarding a result of detection of an ink temperature, to the control unit 9.

The third temperature sensor 86 is interposed on the downstream side of the second heater 77 with respect to the ink delivery direction and on the upstream side of the switch valve 78 with respect to the ink delivery direction in the feedback pipe 65. The third temperature sensor 86 detects a temperature of ink flowing out of the second heater 77. Further, the third temperature sensor 86 is electrically connected to the control unit 9. The third temperature sensor 86 outputs data regarding a result of detection of an ink temperature, to the control unit 9.

Thus, the ink supply unit 4 of the present preferred embodiment includes the temperature sensors 85 and 86 that are interposed between the first and second heaters 76 and 77 and the switch valve 78 in the feedback pipe 65 and detect a temperature of ink in the feedback pipe 65. Note that the first temperature sensor 84, the second temperature sensor 85, and the third temperature sensor 86 described above are not necessarily required to be provided.

The switch valve 78 is interposed on the downstream side of the first and second heaters 76 and 77 and the temperature sensors 84, 85, and 86 and on the upstream side of the filter 87 in the feedback pipe 65. In other words, the switch valve 78 is interposed between the first and second heaters 76 and 77 and the supply tank 51 in the feedback pipe 65. The switch valve 78 is a three-way valve that switches the ink circulation path 41 in the internal passage of the feedback pipe 65 to an ink disposal path with intermediation of the drainage pipe 66. Meanwhile, for the switch valve 78, for example, a solenoid valve that performs a switching operation under the control of the control unit 9 is used. In the switch valve 78, a solenoid (not shown) for switching a destination of ink flow is incorporated. Alternatively, for the switch valve 78, a switch valve that manually performs a switching operation may be used. The switch valve 78 includes a flow inlet 781, a first flow outlet 782, and a second flow outlet 783.

The flow inlet 781 communicates with the first and second heaters 76 and 77 and the temperature sensors 84, 85, and 86. In other words, the flow inlet 781 communicates with an upstream-side portion of the circulation path 41. The first flow outlet 782 communicates with the filter 87. In other words, the first flow outlet 782 communicates with a downstream-side portion of the circulation path 41. The second flow outlet 783 communicates with an internal passage of the drainage pipe 66. Normally, the second flow outlet 783 is closed, and the flow inlet 781 and the first flow outlet 782 communicate with each other. That is, when power is supplied to the switch valve 78 and the solenoid is an ON state (energized), a destination of ink flow from the switch valve 78 is the first flow outlet 782. As a result, the internal passage of the feedback pipe 65 is allowed to communicate. Meanwhile, when the first flow outlet 782 is closed and the flow inlet 781 and the second flow outlet 783 communicate with each other, ink flowing from the flow inlet 781 is directed to the disposal path with intermediation of the drainage pipe 66, to be drained to the outside of the inkjet printing apparatus 1. That is, when no power is supplied to the switch valve 78 and the solenoid is in an OFF state (demagnetized), the destination of ink flow from the switch valve 78 is the second flow outlet 783. In other words, the switch valve 78 can perform a switching operation between a state in which the first and second heaters 76 and 77 communicate with the supply tank 51 and a state in which the first and second heaters 76 and 77 are blocked from communicating with the supply tank 51 and an inner space of the circulation path 41 communicates with the external collecting tank 53 described later.

When the feedback-side on-off valve 75 is closed and the flow inlet 781 and the second flow outlet 783 communicate with each other at the switch valve 78 under the control of the control unit 9 described later, a section from the feedback-side on-off valve 75 to the switch valve 78 in the circulation path 41 is partitioned off from the other sections. Hereinafter, the section from the feedback-side on-off valve 75 to the switch valve 78 in the circulation path 41 is referred to as an “ink separation region 79”. The ink separation region 79 is set in a partial region including the first and second heaters 76 and 77 in the feedback pipe 65. The ink separation region 79 is a region where ink in the circulation path 41 is separated from ink in the other regions in the feedback pipe 65 when the feedback-side on-off valve 75 is closed, to stop ink circulation in the circulation path 41, and the flow inlet 781 and the second flow outlet 783 communicate with each other at the switch valve 78. At that time, in the ink separation region 79, ink flow to/from the other regions in the feedback pipe 65 is restricted. Note that, even though the destination of ink flow from the switch valve 78 is the first flow outlet 782, because of flow resistance of the switch valve 78, ink flow between the ink separation region 79 and a region on the downstream side thereof is restricted. As a result, also in this case, the ink separation region 79 is partitioned off from the other regions in the feedback pipe 65.

The external collecting tank 53 is a container in which ink to be drained to the outside of the circulation path 41 is collected. The external collecting tank 53 is provided outside the circulation path 41 through which ink is circulated between the supply tank 51 and the internal collecting tank 52. In the external collecting tank 53, an internal chamber 530 in which ink can be stored is provided.

The drainage pipe 66 is a pipe that connects the internal chamber 530 of the external collecting tank 53 and the second flow outlet 783 of the switch valve 78 such that they can communicate with each other. The internal passage of the drainage pipe 66 is connected so as to communicate with the second flow outlet 783 of the switch valve 78 at an upstream end thereof. Meanwhile, the internal passage of the drainage pipe 66 is connected so as to communicate with the internal chamber 530 of the external collecting tank 53 at a downstream end thereof. By operating the switch valve 78 so as to cause the inner space of the circulation path 41 and the external collecting tank 53 to communicate with each other as described above, it is possible to deliver ink to the internal chamber 530 of the external collecting tank 53 via the internal passage of the feedback pipe 65, the inner space of the switch valve 78, and the internal passage of the drainage pipe 66.

As described above, in the present preferred embodiment, the feedback-side on-off valve 75 and the switch valve 78 are provided in the ink separation region 79. Further, when the feedback-side on-off valve 75 is closed and the destination of ink flow from the switch valve 78 is switched to the second flow outlet 783 under the control of the control unit 9, the ink separation region 79 and the external collecting tank 53 communicate with each other. Then, ink in the ink separation region 79 is separated from ink in the other regions in the feedback pipe 65.

The filter 87 is interposed on the downstream side of the switch valve 78 and on the upstream side of the deaeration unit 88 in the feedback pipe 65. The filter 87 filters ink delivered through the internal passage of the feedback pipe 65, to remove foreign matters included in the ink.

The deaeration unit 88 is interposed on the downstream side of the filter 87 and on the upstream side of the supply tank 51 in the feedback pipe 65. The deaeration unit 88 of the present preferred embodiment is a so-called hollow-fiber membrane deaeration module. The deaeration unit 88 removes bubbles in ink delivered through the internal passage of the feedback pipe 65.

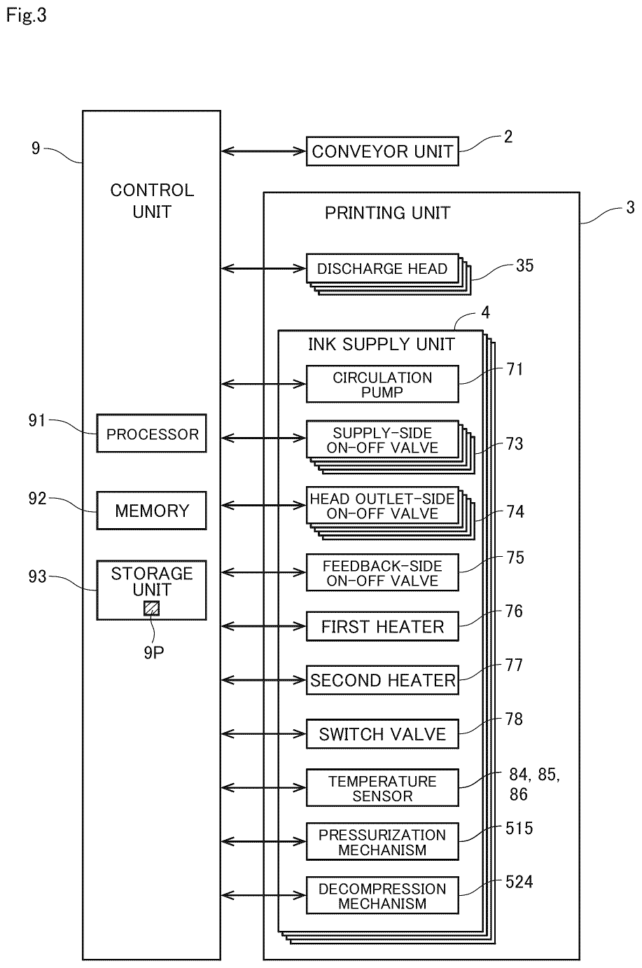

Next, the control unit 9 is described. The control unit 9 is an information processing device configured to control each component of the inkjet printing apparatus 1. FIG. 3 is a block diagram showing connection between the control unit 9 and each component of the inkjet printing apparatus 1. As conceptually shown in FIG. 3, the control unit 9 includes a processor 91 such as a CPU, a memory 92 such as a RAM, and a storage unit 93 such as a hard disk drive. In the storage unit 93, a computer program 9P is stored, which is for performing a printing operation while conveying the continuous paper 10, supplying ink to the discharge heads 35 while circulating a part of ink, and draining ink to the outside of the circulation path 41.

Further, as shown in FIG. 3, the control unit 9 is connected to the conveyor unit 2 and the four discharge heads 35 of the printing unit 3, and is further connected to the circulation pump 71, the five supply-side on-off valves 73, the five head outlet-side on-off valves 74, the feedback-side on-off valve 75, the first heater 76, the second heater 77, the switch valve 78, the respective temperature sensors 84, 85, and 86, the pressurization mechanism 515, and the decompression mechanism 524 of each of the four ink supply units 4 of the printing unit 3 such that the control unit 9 can conduct communication to/from the above-described components. The control unit 9 controls operations of those components in accordance with the computer program 9P.

That is, the control unit 9 can control each of the conveyor unit 2, the four discharge heads 35 of the printing unit 3, and the circulation pump 71, the five supply-side on-off valves 73, the five head outlet-side on-off valves 74, the feedback-side on-off valve 75, the first heater 76, the second heater 77, the switch valve 78, the respective temperature sensors 84, 85, and 86, the pressurization mechanism 515, and the decompression mechanism 524 of each of the four ink supply units 4 of the printing unit 3. By control over operations of those components in the control unit 9, a process of conveying the continuous paper 10 and performing printing thereon proceeds, ink is supplied to the internal tank 82 of each discharge head 35 while a part thereof is circulated, and further, ink is drained to the outside of the circulation path 41 under a predetermined condition. Moreover, as described above, the circulation pump 71 outputs data regarding a driving condition of the circulation pump 71, to the control unit 9. The control unit 9 can detect presence or absence of ink circulation in the circulation path 41 on the basis of the data received from the circulation pump 71.

### <2. Conveyance of Continuous Paper, Printing, Ink Circulation, and Ink Drainage to Outside>

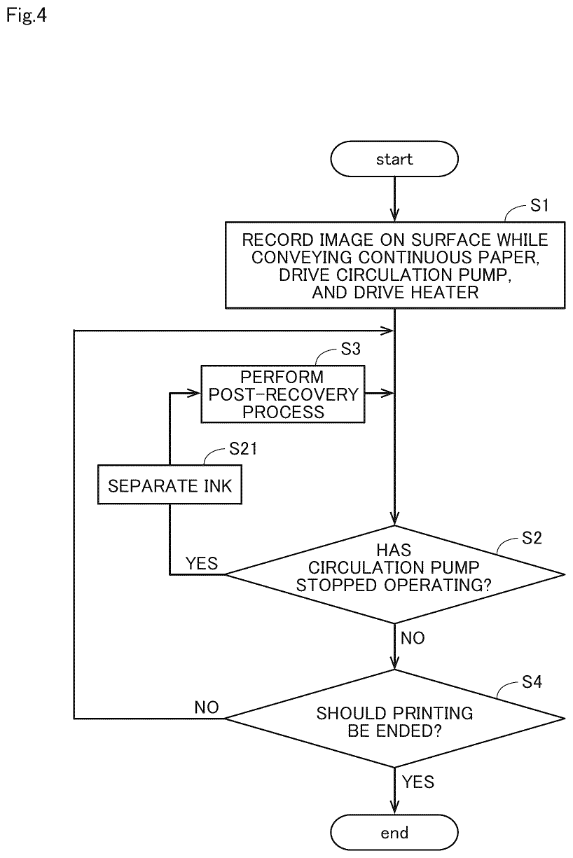

Next, description is given about a procedure for conveyance of the continuous paper 10, printing on the continuous paper 10, ink circulation, and ink drainage to the outside that are performed in the inkjet printing apparatus 1. FIG. 4 is a flowchart showing a flow including conveyance of the continuous paper 10, printing on the continuous paper 10, ink circulation, and ink drainage ink to the outside.

First, in performing conveyance of the continuous paper 10, printing on the continuous paper 10, and ink circulation, the control unit 9 causes the conveyor unit 2 to operate, to convey the continuous paper 10 along the predetermined conveying path in the conveying direction extending along the length direction. Further, the control unit 9 controls the plurality of nozzles 83 of each of the four discharge heads 35 while conveying the continuous paper 10, to discharge ink droplets onto the surface of the continuous paper 10. Thus, an image is recorded on the surface of the continuous paper 10 (step S1).

Meanwhile, as advance preparation for conveyance of the continuous paper 10, printing on the continuous paper 10, and ink circulation, a sufficient amount of ink is stored in the internal chamber 510 of the supply tank 51. Further, the control unit 9 opens the five supply-side on-off valves 73, the five head outlet-side on-off valves 74, and the feedback-side on-off valve 75. Moreover, the control unit 9 closes the second flow outlet 783 of the switch valve 78, to cause the flow inlet 781 and the first flow outlet 782 to communicate with each other.

Then, the control unit 9 drives the circulation pump 71, the first heater 76, the second heater 77, the pressurization mechanism 515, and the decompression mechanism 524 of each of the four ink supply units 4. Specifically, the control unit 9 drives the circulation pump 71, to circulate ink through the ink circulation path 41, and at the same time, drives the pressurization mechanism 515 and the decompression mechanism 524. As a result, ink is supplied to the internal tank 82 of each discharge head 35. Further, the power of the first temperature sensor 84, the second temperature sensor 85, and the third temperature sensor 86 is turned on, and these sensors start measuring.

More specifically, the pressurization mechanism 515 and the decompression mechanism 524 are driven, so that a pressure difference is generated between the internal chamber 510 of the supply tank 51 and the internal chamber 520 of the internal collecting tank 52. As a result, ink stored in the supply tank 51 can be supplied to the discharge heads 35, and further, ink remaining in the discharge heads 35 can be collected into the internal collecting tank 52. Note that the ink remaining in the discharge heads 35 is ink being undischarged from the discharge heads 35 and left in the discharge heads 35. Further, when the circulation pump 71 is driven, there is generated ink flow from the internal collecting tank 52 to the supply tank 51 in the internal passage of the feedback pipe 65.

Moreover, the first and second heaters 76 and 77 are driven, and thus ink delivered through the internal passage of the feedback pipe 65 can be delivered to the supply tank 51 after being heated. More specifically, the control unit 9 first performs control in which a temperature of ink passing through the first heater 76 becomes equal to, for example, the first target temperature T1° C. by switching the first heater 76 between an ON state and an OFF state. As described above, the second temperature sensor 85 detects a temperature of ink flowing out of the first heater 76 and outputs data regarding a result of the detection, to the control unit 9. The control unit 9 adjusts a driving amount of the first heater 76 in accordance with the result of the detection of the ink temperature received from the second temperature sensor 85.

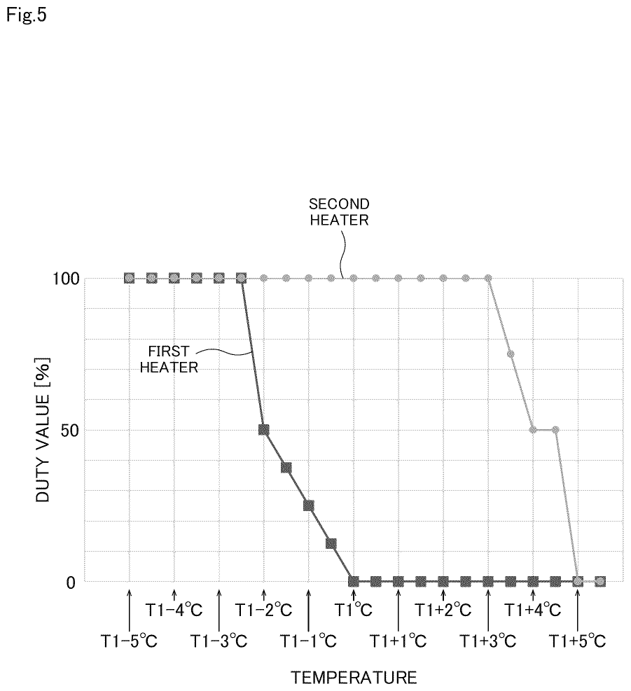

FIG. 5 is a view showing examples of a temperature of ink passing through each of the first and second heaters 76, 77 and a ratio of a time period of an ON state to a unit time period in driving the first and second heaters 76 and 77, plotted against the temperature of ink. The unit time period is, for example, one second. In other words, FIG. 5 is a view showing examples of a temperature of ink passing through each of the first and second heaters 76 and 77 and a duty value in driving each of the first and second heaters 76 and 77, plotted against the temperature of ink. As shown in FIG. 5, when a temperature of ink passing through the first heater 76 is lower than the “first target temperature T1−2.5° C.”, the control unit 9 drives the first heater 76 at a duty value of 100%. When the temperature of ink passing through the first heater 76 becomes equal to or higher than the “first target temperature T1−2.5° C.”, the control unit 9 gradually decreases the duty value. Then, when the temperature of ink becomes equal to or higher than the “first target temperature T1−2° C.”, the control unit 9 drives the first heater 76 at a duty value of 50% or smaller. Further, when the temperature of ink becomes equal to or higher than the “first target temperature T1° C.”, the control unit 9 drives the first heater 76 at a duty value of 0%. In other words, when the temperature of ink becomes equal to or higher than the “first target temperature T1° C.”, the control unit 9 stops driving the first heater 76. By the above-described control, the temperature of ink passing through the first heater 76 can be adjusted to the “first target temperature T1° C.”.

Meanwhile, the control unit 9 performs control in which a temperature of ink passing through the second heater 77 becomes equal to, for example, the second target temperature T2° C. by switching the second heater 77 between an ON state and an OFF state. As described above, the third temperature sensor 86 detects a temperature of ink flowing out of the second heater 77, and outputs data regarding a result of the detection, to the control unit 9. The control unit 9 adjusts a driving amount of the second heater 77 in accordance with the result of the detection of the ink temperature received from the third temperature sensor 86. Here, as described above, a duty value of the second heater 77 is greater than a duty value of the first heater 76.

As shown in FIG. 5, when the temperature of ink passing through the second heater 77 is lower than the “first target temperature T1+3° C.” (corresponding to the second target temperature T2−2° C.), the control unit 9 drives the second heater 77 at a duty value of 100%. When the temperature of ink passing through the second heater 77 becomes equal to or higher than the “first target temperature T1+3° C.” (corresponding to the second target temperature T2−2° C.), the control unit 9 gradually decreases the duty value. Then, when the temperature of ink becomes equal to or higher than the “first target temperature T1+4° C.” (corresponding to the second target temperature T2−1° C.), the control unit 9 drives the second heater 77 at a duty value of 50% or smaller. Further, when the temperature of ink becomes equal to or higher than the “first target temperature T1+5° C.” (corresponding to the second target temperature T2° C.), the control unit 9 drives the second heater 77 at a duty value of 0%. In other words, when the temperature of ink becomes equal to or higher than the “first target temperature T1+5° C.” (corresponding to the second target temperature T2° C.), the control unit 9 stops driving the second heater 77. By the above-described control, the temperature of ink passing through the second heater 77 can be adjusted to the “second target temperature T2° C.”. The adjustment of the temperature of ink passing through the second heater 77 to the second target temperature T2° C. allows the discharge heads 35 to satisfactorily discharge ink afterward.

Meanwhile, as described above, the first temperature sensor 84 detects a temperature of ink flowing into the first heater 76, and outputs data regarding a result of the detection, to the control unit 9. The control unit 9 can find at what temperature ink has originally flowed into the first heater 76, by referring to the data regarding the result of the detection provided from the first temperature sensor 84. This serves as a measure in determination as to whether the first heater 76 and the second heater 77 normally operate.

Further, ink flowing through the internal passage of the feedback pipe 65 is caused to pass through the filter 87, and thus, ink from which small impurities or the like remaining therein have been removed can be delivered to the supply tank 51. Moreover, ink flowing through the internal passage of the feedback pipe 65 is caused to pass through the deaeration unit 88, and thus ink having been deaerated can be delivered to the supply tank 51.

Here, suppose that a power failure occurs and power supply to the inkjet printing apparatus 1 is interrupted, for example. In this case, also power supply to the circulation pump 71 is interrupted, so that the circulation pump 71 stops operating. In another supposed case, when an operator detects ink leakage from the ink circulation path 41, an excessive decrease of the liquid level of ink stored in the internal chamber 510 of the supply tank 51, or overflow of ink stored in the internal chamber 530 of the external collecting tank 53, the operator himself stops driving the circulation pump 71. In those cases, ink circulation in the circulation path 41 is stopped, and thus ink stays in each of the first and second heaters 76 and 77.

In this regard, as described above, each of the first and second heaters 76 and 77 includes a heating element formed of a carbon heater or the like. The heating element is kept at a high temperature even after interruption of power supply to the first and second heaters 76 and 77. Hence, to leave ink circulation stopped for a certain time period would result in excessively heating the ink staying in the first and second heaters 76 and 77, so that the ink might possibly be changed in quality or deteriorated. Further, to use ink having been changed in quality or deteriorated afterward would cause a fear that ink might not be satisfactorily discharged from the discharge heads 35 or a desired color gamut might not be obtained.

Thus, the control unit 9 first detects whether the circulation pump 71 has stopped operating (step S2). A state in which the circulation pump 71 has stopped operating includes a case in which a power failure occurs and the circulation pump 71 automatically stops operating due to interruption of power supply to the circulation pump 71, and a case in which an operator himself stops driving the circulation pump 71. The control unit 9 continues conveyance of the continuous paper 10, printing on the continuous paper 10, and ink circulation until it is detected that the circulation pump 71 has stopped operating (step S2: NO). Meanwhile, when it is detected that the circulation pump 71 has stopped operating (step S2: YES), the control unit 9 performs an ink separation step S21 described below.

The feedback-side on-off valve 75 is a solenoid valve of a normally closed type as described above, and thus, is automatically closed when power supply to the feedback-side on-off valve 75 is interrupted due to a power failure or the like. Alternatively, the control unit 9 may transmit a control signal for interrupting ink flow to the feedback-side on-off valve 75 when the control unit 9 detects a stop of ink circulation in the circulation path 41. Further alternatively, an operator may manually close the feedback-side on-off valve 75. Thus, when ink circulation in the circulation path 41 stops due to a power failure or the like, the ink separation region 79 is partitioned off from the other regions in the feedback pipe 65 (step S21).

Further, as described above, when the solenoid incorporated in the switch valve 78 is in a demagnetized (OFF) state, a destination of ink flow is switched to the second flow outlet 783. Thus, when power supply to the switch valve 78 stops due to a power failure or the like, a destination of ink flow is automatically switched to the second flow outlet 783. Alternatively, the control unit 9 may transmit a control signal for switching a destination of ink flow to the second flow outlet 783, to the switch valve 78 when the control unit 9 detects a stop of ink circulation in the circulation path 41. Further alternatively, an operator may manually switch a destination of ink flow of the switch valve 78 to the second flow outlet 783. In the above-described manner, the ink separation step S21 is performed.

After performing the ink separation step S21, the control unit 9 recovers from a power failure and eliminates ink leakage or the like, and after then performs a post-recovery process (step S3) when performing conveyance of the continuous paper 10, printing on the continuous paper 10, and ink circulation again.

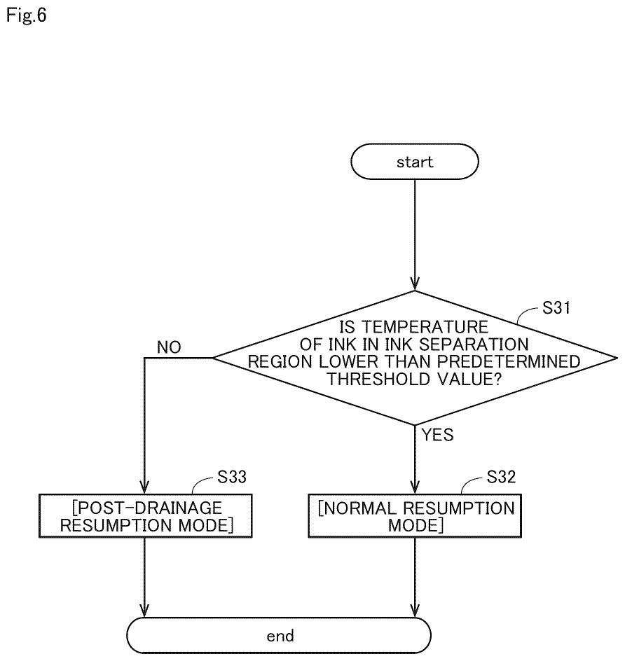

FIG. 6 is a flowchart showing a procedure for performing the post-recovery process. As described in detail below, for the post-recovery process, the control unit 9 can selectively perform a “normal resumption mode” and a “post-drainage resumption mode”. That is, after the ink separation step S21 is performed and recovery from a power failure is achieved or ink leakage or the like is eliminated, the control unit 9 selectively performs the “normal resumption mode” and the “post-drainage resumption mode”. Meanwhile, the control unit 9 can determine whether recovery from a power failure has been achieved or whether ink leakage or the like has been eliminated, according to presence or absence of resumption of power supply to the inkjet printing apparatus 1, or from an input operation or the like by an operator.

As shown in FIG. 6, before resuming ink circulation in the circulation path 41, the control unit 9 first determines whether a temperature of ink in the ink separation region 79 is lower than a predetermined threshold value, or equal to or higher than the predetermined threshold value (step S31). To this end, the control unit 9 refers to each of a duty value of the first heater 76 and a duty value of the second heater 77 for a first predetermined time period before it is detected that ink circulation in the circulation path 41 has stopped, in making the foregoing determination. For example, the control unit 9 refers to each of a duty value of the first heater 76 and a duty value of the second heater 77 in one second long being prior to the point at which it is detected that ink circulation in the circulation path 41 has stopped. Note that the duty value varies in some cases, as described above. Hence, the control unit 9 may set a time period of approximately a few minutes as the first predetermined time period and refer to integral values of duty values of the respective first and second heaters 76 and 77 for the set time period.

When the duty value for the first predetermined time period before it is detected that ink circulation has stopped is large, the control unit 9 determines that the respective heating elements have continued generating much heat in the first and second heaters 76 and 77 also during a stop of ink circulation. In this case, the control unit 9 determines that ink staying in the first and second heaters 76 and 77 has been excessively heated and is highly likely to have been changed in quality or deteriorated. Then, the control unit 9 determines whether a temperature of ink in the ink separation region 79 is lower than, or equal to or higher than, the threshold value on the basis of a result of referring to the duty values.

More specifically, after detecting that ink circulation in the circulation path 41 has stopped, the control unit 9 determines whether a temperature of ink in the first heater 76 is lower than, or equal to or higher than, a first predetermined threshold value before resuming ink circulation in the circulation path 41. Meanwhile, after detecting that the ink circulation in the circulation path 41 has stopped, the control unit 9 determines whether a temperature of ink in the second heater 77 is lower than, or equal to or higher than, a second predetermined threshold value before resuming ink circulation in the circulation path 41. In this manner, in the present preferred embodiment, ink can be drained as later described in accordance with a result of determination as to whether an ink temperature is lower than, or equal to or higher than, the predetermined threshold value with consideration of heating values of the first and second heaters 76 and 77.

Alternatively, the control unit 9 may determine whether the temperature of ink in the ink separation region 79 is lower than, or equal to or higher than, the predetermined threshold value on the basis of a result of detection provided from the second temperature sensor 85 placed on the downstream side of the first heater 76 and a result of detection provided from the third temperature sensor 86 placed on the downstream side of the second heater 77. Then, in ink drainage described later, when it is determined that ink is at a sufficiently low temperature on the basis of the results of detections provided from the temperature sensors 85 and 86, the control unit 9 may stop draining ink to the outside at that time point.

Then, when it is determined that the temperature of ink in the ink separation region 79 is lower than the predetermined threshold value (step S31: YES), the control unit 9 performs the “normal resumption mode” (step S32). More specifically, when it is determined that the temperature of ink in the first heater 76 is lower than the first predetermined threshold value and the temperature of ink in the second heater 77 is lower than the second predetermined threshold value, the control unit 9 performs the “normal resumption mode”. That is, the control unit 9 performs the “normal resumption mode” in accordance with the temperature of ink in the ink separation region 79. In this case, for the “normal resumption mode”, the control unit 9 causes the ink separation region 79 and the other regions in the feedback pipe 65 to communicate with each other immediately. Specifically, the control unit 9 closes the second flow outlet 783 of the switch valve 78 and causes the flow inlet 781 and the first flow outlet 782 to communicate with each other, and thus the first and second heaters 76 and 77 communicate with the supply tank 51. Further, the control unit 9 opens the feedback-side on-off valve 75. Subsequently, the control unit 9 drives the circulation pump 71 to resume ink circulation, and performs conveyance of the continuous paper 10, printing on the continuous paper 10, and ink circulation.

Meanwhile, when it is determined that the temperature of ink in the ink separation region 79 is equal to or higher than the predetermined threshold value (step S31: NO), the control unit 9 performs the “post-drainage resumption mode” (step S33). For example, when it is determined that the temperature of ink in the first heater 76 is lower than the first predetermined threshold value and the temperature of ink in the second heater 77 is equal to or higher than the second predetermined threshold value, the control unit 9 performs the “post-drainage resumption mode”. That is, the control unit 9 performs the “post-drainage resumption mode” in accordance with the temperature of ink in the ink separation region 79. In this case, for the “post-drainage resumption mode”, the control unit 9 closes the first flow outlet 782 of the switch valve 78, to cause the flow inlet 781 and the second flow outlet 783 to communicate with each other. As a result, the inner space of the circulation path 41 and the external collecting tank 53 communicate with each other. Further, the control unit 9 opens the feedback-side on-off valve 75. Then, the control unit 9 drives the circulation pump 71 for a “specific time period” and drains ink in the ink separation region 79 to the external collecting tank 53. After that, the control unit 9 causes the ink separation region 79 and the other regions in the feedback pipe 65 to communicate with each other again, as described later.

Here, the “specific time period” is, for example, a value obtained by division of a sum of a volume of a section from the switch valve 78 to the second heater 77 in the internal passage of the feedback pipe 65 and a volume of the inner space of the second heater 77, by a pumping amount of the circulation pump 71 per unit time period. In other words, the “specific time period” is a value obtained by division of a specific capacity calculated from an ink-passable capacity of the second heater 77, by a pumping amount of the circulation pump 71 per unit time period. Thus, ink that is likely to have been deteriorated due to overheating by the second heater 77 can be drained to the outside of the circulation path 41. Further, it is possible to narrow ink to be drained at that time, down to ink that is likely to have been deteriorated due to overheating by the second heater 77.

In this regard, an amount of ink to be drained to the external collecting tank 53 may be all of ink in the ink separation region 79. Alternatively, an amount of ink to be drained to the external collecting tank 53 may be an amount that is further reduced by referring to the temperature of ink in the first heater 76 and the temperature of ink in the second heater 77. That is, the control unit 9 selects the “post-drainage resumption mode” in accordance with the temperature of ink in the ink separation region 79, opens the feedback-side on-off valve 75, and causes the ink separation region 79 and the external collecting tank 53 to communicate with each other at the switch valve 78. Then, the control unit 9 drives the circulation pump 71 and drains at least a part of ink in the ink separation region 79 to the external collecting tank 53. After that, the control unit 9 causes the ink separation region 79 and the other regions in the feedback pipe 65 to communicate with each other again as described later.

Further, when it is determined that the temperature of ink in the first heater 76 is equal to or higher than the first predetermined threshold value and the temperature of ink in the second heater 77 is equal to or higher than the second predetermined threshold value, the control unit 9 performs the “post-drainage resumption mode” in the same manner as described above. In this case, the control unit 9 operates the switch valve 78 in the same manner as described above, opens the feedback-side on-off valve 75, and drives the circulation pump 71 for a “specific time period”. In this case, the “specific time period” is, for example, a value obtained by division of a sum of a volume of a section from the switch valve 78 to the first heater 76 in the internal passage of the feedback pipe 65, a volume of the inner space of the second heater 77, and a volume of the inner space of the first heater 76, by a pumping amount of the circulation pump 71 per unit time period.

Specifically, when it is determined that the temperature of ink in the ink separation region 79 is equal to or higher than the predetermined threshold value, the control unit 9 causes the ink separation region 79 and the external collecting tank 53 to communicate with each other at the switch valve 78. Further, the control unit 9 opens the feedback-side on-off valve 75. Then, the circulation pump 71 is driven for the “specific time period”, and ink in the ink separation region 79 is drained to the external collecting tank 53. Thus, in a case in which ink circulation stops, ink that is likely to have been changed in quality or deteriorated due to overheating can be drained to the outside in accordance with the temperature of the ink, in recovery afterward. Meanwhile, in draining ink to the external collecting tank 53, all of ink in the circulation path 41 is not drained. In the present preferred embodiment, only ink that is likely to have been changed in quality or deteriorated due to overheating by the second heater 77, or only ink that is likely to have been changed in quality or deteriorated due to overheating by both of the first heater 76 and the second heater 77, in the ink separation region 79, is drained to the external collecting tank 53. This enables reduction of an amount of ink to be drained.

Meanwhile, in performing the “post-drainage resumption mode”, the control unit 9 stops driving the first and second heaters 76 and 77 at least until the ink separation region 79 and the other regions in the feedback pipe 65 communicate with each other as described later. This enables further suppression of overheating of ink.

As described above, after the circulation pump 71 is driven for the “specific time period” and ink in the ink separation region 79 is drained to the external collecting tank 53, the control unit 9 closes the second flow outlet 783 of the switch valve 78 again. Thus, the control unit 9 causes the flow inlet 781 and the first flow outlet 782 to communicate with each other, to thereby cause the first and second heaters 76 and 77 and the supply tank 51 to communicate with each other. That is, the control unit 9 causes the ink separation region 79 and the other regions in the feedback pipe 65 to communicate with each other again. Further, the control unit 9 opens the feedback-side on-off valve 75. Then, the control unit 9 drives the circulation pump 71 to resume ink circulation, and performs conveyance of the continuous paper 10, printing on the continuous paper, and ink circulation. Moreover, the control unit 9 drives the first and second heaters 76 and 77 again, and adjusts driving amounts of the first and second heaters 76 and 77 in accordance with results of detection of ink temperatures received form the temperature sensors 85 and 86.

As shown in FIG. 4, after that, the control unit 9 determines whether to end conveyance of the continuous paper 10 and printing (step S4). The control unit 9 continues conveyance of the continuous paper 10 and printing when there remains image data to be printed (step S4: NO). After a while, when there is no image data to be printed (step S4: YES), the control unit 9 stops operations of each component and ends conveyance of the continuous paper 10, printing on the continuous paper 10, and ink circulation.

### <3. Modifications>

Hereinabove, the preferred embodiment of the present invention has been described, but the present invention is not limited to the above-described preferred embodiment.

In the above-described preferred embodiment, in draining ink in the ink separation region 79 to the external collecting tank 53 in the “post-drainage resumption mode”, the feedback-side on-off valve 75 is opened and the circulation pump 71 is driven. Alternatively, ink in the inner space of the circulation path 41 may be drained to the external collecting tank 53 by pressurization of a side where the circulation path 41 is provided and decompression of a side where the external collecting tank 53 is provided, using a pressurization mechanism and a decompression mechanism that are additionally provided, without opening the feedback-side on-off valve 75 or driving the circulation pump 71.

Further, the respective elements described in the above-described preferred embodiment and the modification may be appropriately combined unless contradiction occurs.

While the invention has been shown and described in detail, the foregoing description is in all aspects illustrative and not restrictive. It is therefore understood that numerous modifications and variations can be devised without departing from the scope of the invention.

What is claimed is:

1. An inkjet printing apparatus that discharges ink onto a printing medium to perform printing, comprising:
an ink circulation path including a discharge head configured to discharge ink, a supply tank in which ink supplied to the discharge head is stored, an internal collecting tank in which ink collected from the discharge head is stored, and a feedback pipe connecting the internal collecting tank and the supply tank;
an external collecting tank in which ink drained to outside of the circulation path is collected;
a circulation pump that is interposed in the feedback pipe and is configured to deliver ink from the internal collecting tank to the supply tank via the feedback pipe;
a heater that is interposed between the circulation pump and the supply tank in the feedback pipe and is configured to heat ink flowing from the internal collecting tank to the supply tank;
a control unit configured to control the discharge head, the circulation pump, and the heater, and detect presence or absence of ink circulation in the circulation path; and
an ink separation region in which ink in the circulation path is separated from ink in the other regions in the feedback pipe when the ink circulation in the circulation path stops, the ink separation region being set in a partial region including the heater in the feedback pipe, wherein,
the control unit selectively performs a normal resumption mode in which the ink separation region and the other regions in the feedback pipe are caused to communicate with each other immediately, and a post-drainage resumption mode in which the ink separation region and the other regions in the feedback pipe are caused to communicate with each other after at least a part of ink in the ink separation region is drained to the external collecting tank, in accordance with a temperature of the ink in the ink separation region, before resuming the ink circulation in the circulation path.

2. The inkjet printing apparatus according to claim 1, further comprising:
an on-off valve that is interposed between the circulation pump and the heater in the feedback pipe and is configured to allow or interrupt ink flow from the internal collecting tank to the supply tank; and
a switch valve that is interposed between the heater and the supply tank in the feedback pipe and is configured to perform switching between a state in which the heater and the supply tank communicate with each other and a state in which the heater and the supply tank are blocked from communicating with each other, and in the latter state, an inner space of the circulation path and the external collecting tank communicate with each other,
wherein
the on-off valve and the switch valve are provided in the ink separation region,
the control unit is configured to further control the on-off valve and the switch valve, and
under the control of the control unit, the on-off valve is closed, and the ink separation region and the external collecting tank communicate with each other at the switch valve, so that the ink in the ink separation region is separated from the ink in the other regions in the feedback pipe.

3. The inkjet printing apparatus according to claim 2, wherein, in the post-drainage resumption mode, under the control of the control unit, the on-off valve is opened, and the circulation pump is driven while the ink separation region and the external collecting tank communicate with each other at the switch valve, so that at least the part of the ink in the ink separation region is drained to the external collecting tank.

4. The inkjet printing apparatus according to claim 1, wherein the control unit determines whether the temperature of the ink in the ink separation region is lower than a predetermined threshold value, or is equal to or higher than the predetermined threshold value, performs the normal resumption mode when it is determined that the temperature of the ink in the ink separation region is lower than the predetermined threshold value, and performs the post-drainage resumption mode when it is determined that the temperature of the ink in the ink separation region is equal to or higher than the predetermined threshold value.

5. The inkjet printing apparatus according to claim 4, wherein the control unit determines whether the temperature of the ink in the ink separation region is lower than, or equal to or higher than, the predetermined threshold value on the basis of a duty value of the heater for a first predetermined time period before it is detected that the ink circulation in the circulation path has stopped.

6. The inkjet printing apparatus according to claim 4, further comprising
a temperature sensor that is interposed between the heater and the switch valve in the feedback pipe and is configured to detect a temperature of ink in the feedback pipe, wherein
the control unit determines whether the temperature of the ink in the ink separation region is lower than, or equal to or higher than, the predetermined threshold value on the basis of a result of detection provided from the temperature sensor.

7. The inkjet printing apparatus according to claim 1, wherein, in performing the post-drainage resumption mode, the control unit stops driving the heater at least until the ink separation region and the other regions in the feedback pipe communicate with each other.

8. The inkjet printing apparatus according to claim 2, further comprising
a first heater and a second heater that are interposed in the feedback pipe while being arranged adjacently to each other along the circulation path, as the heater, wherein
the second heater is positioned on a downstream side of the first heater in the circulation path and has a duty value greater than a duty value of the first heater,
before resuming the ink circulation in the circulation path, the control unit determines whether a temperature of ink in the first heater is lower than, or equal to or higher than, a first predetermined threshold value, and whether a temperature of ink in the second heater is lower than, or equal to or higher than, a second predetermined threshold value,
when it is determined that the temperature of the ink in the first heater is lower than the first predetermined threshold value and the temperature of the ink in the second heater is equal to or higher than the second predetermined threshold value, the control unit performs the post-drainage resumption mode in which the inner space of the circulation path and the external collecting tank are caused to communicate with each other at the switch vale, the circulation pump is driven for a specific time period, the ink in the ink separation region is drained to the external collecting tank, and then, the ink separation region and the other regions in the feedback pipe are caused to communicate with each other at the switch valve, and
the specific time period is obtained by division of a specific capacity calculated from an ink-passable capacity of the second heater, by a pumping amount of the circulation pump per unit time period.
